(19) United States
(12) Patent Application Publication
(10) Pub. No.: US 2024/0376757 A1
(43) Pub. Date: Nov. 14, 2024

(54) Door Stopper

(71) Applicant: JIEYANG MEILONG HARDWARE PRODUCTS CO., LTD., Jieyang (CN)

(72) Inventor: Xuwen Lin, Jieyang (CN)

(21) Appl. No.: 18/250,037

(22) PCT Filed: Aug. 4, 2022
(86) PCT No.: PCT/CN2022/110379

§ 371 Date: Apr. 21, 2023

(30) Foreign Application Priority Data
May 20, 2022 (CN) 202221248339.X

(51) Int. Cl. E05C 19/00

(52) U.S. Cl. CPC E05C 19/003

(57) ABSTRACT

A door stopper is disclosed including an insertion plate, a baffle assembly, a driven assembly and a reset structure, where the driven assembly is movably arranged on the baffle assembly and has unlocking and locking positions, and the reset structure is configured for driving the driven assembly to restore to the unlocking position when the locking structure is unlocked. During use, the door stopper can be fixedly installed on the door leaf or door pocket via a connection portion. The baffle assembly can slide towards the connection portion in the length direction of the insertion plate so as to stop the door leaf, while the driven assembly can be kept at the locking position to prevent the door leaf from being opened from outside when the locking structure is unlocked.

### TECHNICAL FIELD

The disclosure relates to the technical field of daily necessities, in particular to a door stopper.

### BACKGROUND

Door stopper is mainly fixed at the back of a door to prevent illegal intrusion when people travel or stay in a hotel on business. When using the existing door stopper, an insertion plate is usually inserted into the gap between the door leaf and door pocket for fixing after door closing, a baffle can be matched with the rack of insertion plate and clamped with different latches so as to match with door leaves in different thicknesses. The door stopper is generally locked by a locking structure to prevent the baffle from being separated from the latches so as to achieve the function of safe stopping. However, these locking structures are often automatically restored to a locked state, so users have to apply continuous force to unlock during the installation of the door stopper so as to make the baffle clamped with different latches, which is low in efficiency and inconvenient to install and use.

### SUMMARY

Aiming to solve at least one of the technical problems in the existing technology, the disclosure proposes a door stopper. Through a reset structure, a driven assembly and a latch structure are kept in a separated state when a locking structure is unlocked. Therefore, users can slide the baffle assembly to adjust the clamping position to achieve quick installation and usage of the door stopper.

According to embodiments in the first aspect of the disclosure, a door stopper includes an insertion plate, a baffle assembly, a driven assembly and a reset structure. The insertion plate is provided with a connection portion and a latch structure, wherein the connection portion is configured for connecting with a door leaf or a door pocket, the latch structure is provided with a plurality of latches arranged in a length direction of the insertion plate. The baffle assembly is arranged slidably on the insertion plate and is configured to slide towards or away from the connection portion in the length direction of the insertion plate. The driven assembly is movably arranged on the baffle assembly and has locking and unlocking positions, wherein at the unlocking position, the driven assembly is separated from the latch structure so as to allow the baffle assembly to slide in the length direction of the insertion plate, and at the locking position, the driven assembly is clamped with the latch structure to prevent the baffle assembly from sliding in the length direction of the insertion plate. The driven assembly is provided with a locking structure which is capable of being locked to keep the driven assembly at the locking position and unlocked when the driven assembly is applied with a force. The reset structure is configured for driving the driven assembly to restore to the unlocking position when the locking structure is unlocked.

The door stopper in the embodiments of the disclosure has the following advantageous effect.

During use, the door stopper of the disclosure can be fixedly installed on the door leaf or the door pocket by means of the connection portion. When the baffle assembly slides towards the connection portion in the length direction of the insertion plate, the door leaf can be stopped by the baffle assembly, and the driven assembly can be kept at the locking position by the locking structure to prevent the door leaf from being opened from outside. When the driven assembly is applied with a force to unlock the locking structure, the reset structure can restore the driven assembly to the unlocking position, the driven assembly and the latch structure are kept in a separated state, so users can adjust the installation position of the baffle assembly by easily sliding the baffle assembly to clamp with different latches of the insertion plate, which makes the installation and usage of the door stopper more convenient and quick.

According to some embodiments of the disclosure, the reset structure includes an elastic reset piece arranged on the baffle assembly, and the elastic reset piece is connected with the driven assembly so that the driven assembly can be restored to the unlocking position by means of an elastic force.

According to some embodiments of the disclosure, the driven assembly includes a driven piece and a driving piece. The driven piece is movably arranged on the baffle assembly, the driving piece is connected rotatably with the baffle assembly via a rotating shaft and the driving piece is configured to rotate around the rotating shaft so that the driven piece can be driven to clamp with or separate from the latch structure.

According to some embodiments of the disclosure, the driving piece is provided with a protruding portion arranged on the peripheral wall in a rotating direction of the rotating shaft. By rotating the driving piece, the protruding portion is driven to abut against the driven piece to drive the driven piece to approach to and clamp with the latch structure.

According to some embodiments of the disclosure, the driving piece is provided with a mating portion on the protruding portion, and the driven piece is provided with a groove portion matched with the mating portion. The mating portion can enter and clamp with the groove portion when the protruding portion abuts against the driven piece so as to lock the locking structure, and the matching portion can be separated from the groove portion when the driven piece is applied with a force so as to unlock the locking structure.

According to some embodiments of the disclosure, an outer wall surface of the mating portion and an inner wall surface of the groove portion are arc-shaped. By rotating the driving piece, the mating portion can slide into or out of the groove portion along the inner wall surface of the groove portion.

According to some embodiments of the disclosure, the driven assembly is provided with at least two clamping portions matched with the latches, and the least two clamping portions are configured to be respectively clamped with the latches to prevent the baffle assembly from sliding in the length direction of the insertion plate.

According to some embodiments of the disclosure, the driven assembly is connected slidably with the baffle assembly. A guiding structure is arranged between the driven assembly and the baffle assembly and configured for limiting a sliding direction of the driven assembly. The driven assembly can slide toward and clamp with the latch structure or slide away and separate from the latch structure via the guiding structure.

According to some embodiments of the disclosure, the guiding structure includes a sliding block and a sliding groove, one of the sliding block and the sliding groove is arranged on the baffle assembly, and the other one of the sliding block and the sliding groove is arranged on the driven assembly.

According to some embodiments of the disclosure, the connection portion is rotatably connected with the insertion plate, and the insertion plate can flip over relative to the connection portion.

The additional aspects and advantages of the disclosure will be described below, while some may become apparent in the following description or known through the practices in the disclosure.

### BRIEF DESCRIPTION OF THE DRAWINGS

The above and/or additional aspects and advantages of the disclosure may become apparent and easy to understand through the description of embodiments in combination with following drawings, where:

FIG. 1 is a stereogram of a door stopper according to an embodiment of the disclosure;

FIG. 2 is an internal structure diagram of a door stopper according to an embodiment of the disclosure;

FIG. 3 is a structure diagram of a door stopper according to an embodiment of the disclosure;

FIG. 4 is an internal structure diagram of a door stopper according to an embodiment of the disclosure from another perspective;

FIG. 5 is a partial enlarged drawing at Position A in FIG. 4;

FIG. 6 is a front view of a door stopper according to an embodiment of the disclosure;

FIG. 7 is a breakdown structure diagram of a door stopper according to an embodiment of the disclosure.

### REFERENCE NUMERALS

insertion plate 100, connection portion 110, latch structure 120, latches 121, baffle assembly 200, movable baffle 210, bottom shell 220, sliding block 201, driven assembly 300, driven piece 310, groove portion 311, clamping portion 312, sliding groove 301, driving piece 320, protruding portion 321, mating portion 322, reset structure 400 and magnet 500.

### DETAILED DESCRIPTION

The embodiments of the disclosure are described in details below. Examples are shown in the accompany drawings, wherein identical or similar symbols throughout indicate identical or similar elements or the elements with identical or similar functions. The embodiments described below by reference to the accompany drawings are illustrative and are only intended to explain the disclosure but not regarded as a restriction to the disclosure.

In the description of the disclosure, it should be understood that the direction or positional relationship indicated by the terms such as “up”, “down”, “front”, “back”, “left”, “right”, “vertical”, “horizontal”, “top”, “bottom”, “inside” and “outside” are based on the orientation or positional relationship shown in the drawings, which are only for facilitating the description of the disclosure, rather than indicating or implying that the device or element must have a specific orientation or be constructed and operated in a specific orientation. Therefore, they should not be regarded as a restriction to the disclosure.

In the description of the disclosure, the meaning of “several” is “one or more”, and the meaning of “a plurality of” is two or more. The meaning of “larger than, smaller than or exceed” is understood as excluding the following number, while the meaning of “above, below and within” is understood as including the following number. The term “first”, “second” or the like is only used for distinguishing between the technical features, but shall not be regarded as indicating or implying relative importance or implying the number or sequence of indicated technical features.

In the description of the disclosure, it should be noted that unless otherwise specified and defined clearly, the terms “install”, “interconnect”, “connect” shall be understood broadly, for example, it may refer to fixed connection, detachable connection, integral connection, mechanical connection, electrical connection, direct connection, indirect connection through a medium, or communication inside two elements. For a person of ordinary skill in the art, the specific meaning of the above terms in the disclosure can be understood according to specific situations.

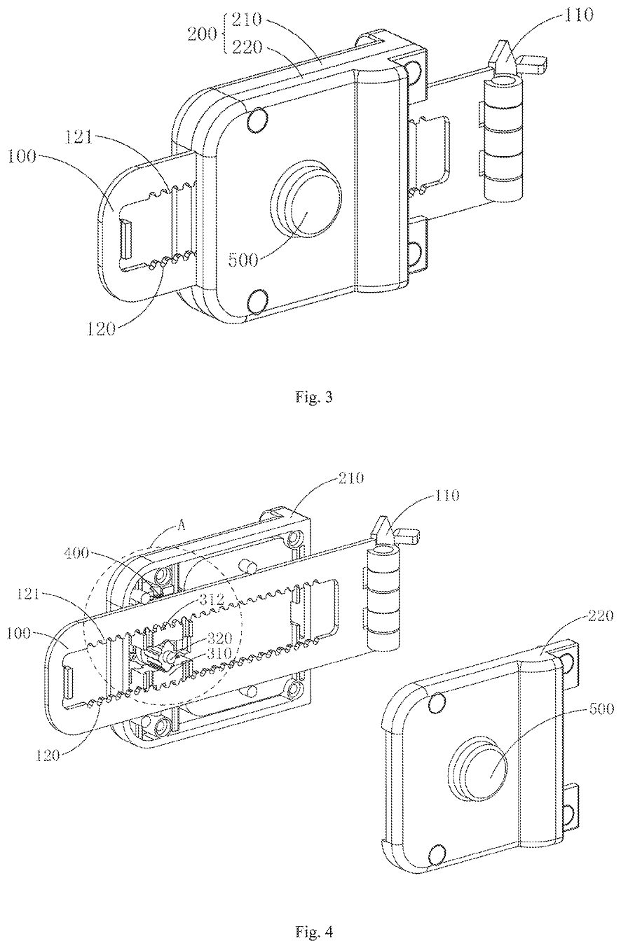

Referring to FIG. 1-7, a door stopper according to an embodiment of the disclosure includes an insertion plate 100, a baffle assembly 200, a driven assembly 300 and a reset structure 400. The insertion plate 100 is provided with a connection portion 110 and a latch structure 120, the connection portion 110 is configured for connecting with a door leaf or a door pocket. The latch structure 120 is provided with a plurality of latches 121 arranged in a length direction of the insertion plate 100. The baffle assembly 200 is arranged slidably on the insertion plate 100 and can slide toward or away from the connection portion 110 in the length direction of the insertion plate 100. The driven assembly 300 is movably arranged on the baffle assembly 200 and has unlocking and locking position on the baffle assembly, wherein at the unlocking position the driven assembly 300 is separated from the latch structure 120 so as to allow the baffle assembly 200 to slide in the length direction of the insertion plate 100, and at the locking position, the driven assembly 300 is clamped with the latch structure 120 to prevent the baffle assembly 200 from sliding in the length direction of the insertion plate 100. Besides, the driven assembly 300 is provided with a locking structure, and the locking structure can be locked to keep the driven assembly 300 at the locking position or unlock when the driven assembly 300 is applied with a force. The reset structure 400 is configured for driving the driven assembly 300 to restore to the unlocking position when the locking structure is unlocked.

Referring to FIG. 1-7, the baffle assembly 200 includes a movable baffle 210 and a bottom shell 220. The movable baffle 210 abuts against the door leaf to stop the door leaf from opening. The reset structure 400 may be either a hammer which restores the driven assembly 300 to the unlocking position by means of gravity or a torsion spring which restores the driven assembly 300 to the unlocking position by means of an elastic force. Referring to FIG. 1-7, during use, the door stopper may be fixedly installed on the door pocket via the connection portion 110, then the door leaf is closed, at this moment, the driven assembly 300 is unlocked so that users can slide the baffle assembly 200 toward the connection portion 100 in the length direction of the insertion plate 100, and the driven assembly 300 is kept at the locking position by locking of the locking structure, so that the driven assembly 300 and the latch structure 120 are kept in a clamping state, and the door leaf can be prevented from being opened from outside by the baffle assembly 200 to achieve the function of safe stopping. It should be noted that the reset structure 400 may restore the driven assembly 300 to the unlocking position automatically when the users apply the force to the driven assembly 300 to unlock the locking structure, and the driven assembly 300 and the latch structure 120 are maintained in a separated state. Therefore, users can easily slide the baffle assembly 200 to clamp with different latches 121 of the insertion plate 100, so that the installation position of the baffle assembly 200 can be adjusted, the baffle assembly 200 can abut against the door leaf tightly to prevent the door leaf from being opened from outside, and the door stopper is more convenient and quick to install and use.

In some embodiments of the disclosure, as shown in FIG. 4-5 and FIG. 7, the reset structure 400 includes an elastic reset piece arranged on the baffle assembly 200, and the elastic reset piece is connected with the driven assembly 300 so that the driven assembly 300 can be restored to the unlocking position by means of an elastic force.

Specifically, as shown in FIG. 4-5 and FIG. 7, the reset structure 400 may be a spring which can restore the driven assembly 300 to the unlocking position automatically by means of an elastic force, and the spring is easy to obtain, convenient to use and reliable to reset.

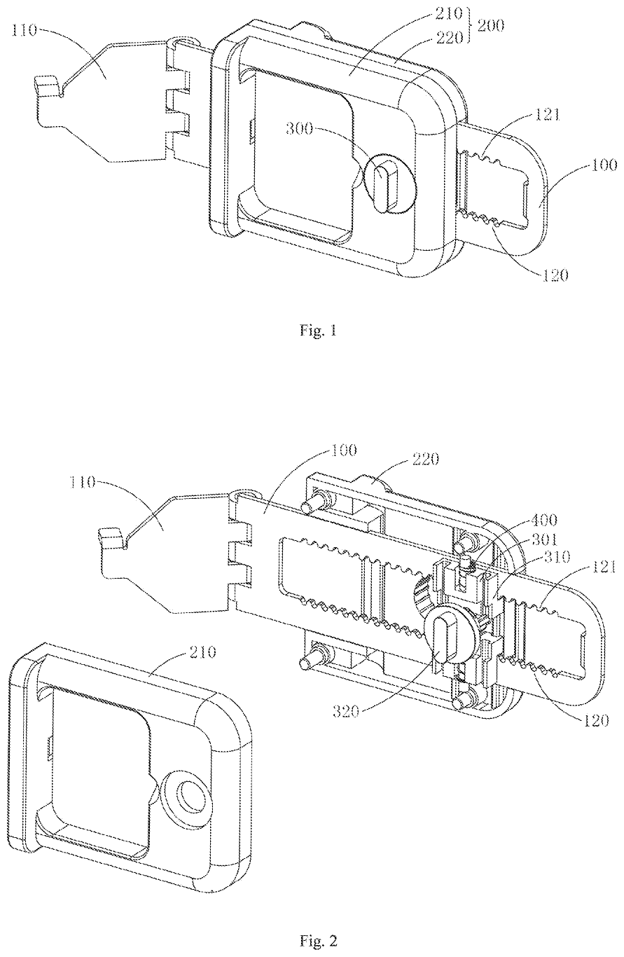

In some embodiments of the disclosure, as shown in FIG. 2, FIG. 4-5 and FIG. 7, the driven assembly 300 includes a driven piece 310 and a driving piece 320. The driven piece 310 is movably arranged on the baffle assembly 200, the driving piece 320 is rotatably connected with the baffle assembly 200 via a rotating shaft, and the driving piece 320 is configured to rotate around the rotating shaft so that the driven piece 310 can be driven to clamp with or separate from the latch structure 120.

It should be noted that the driving piece 320 is driven to be clamped with or separated from the latch structure 120 by rotating around the rotating shaft to achieve locking and unlocking, and the short rotating stroke makes the internal structure of the door stopper more compact, which is conducive to reducing the volume of the door stopper and making it easy for users to carry and use.

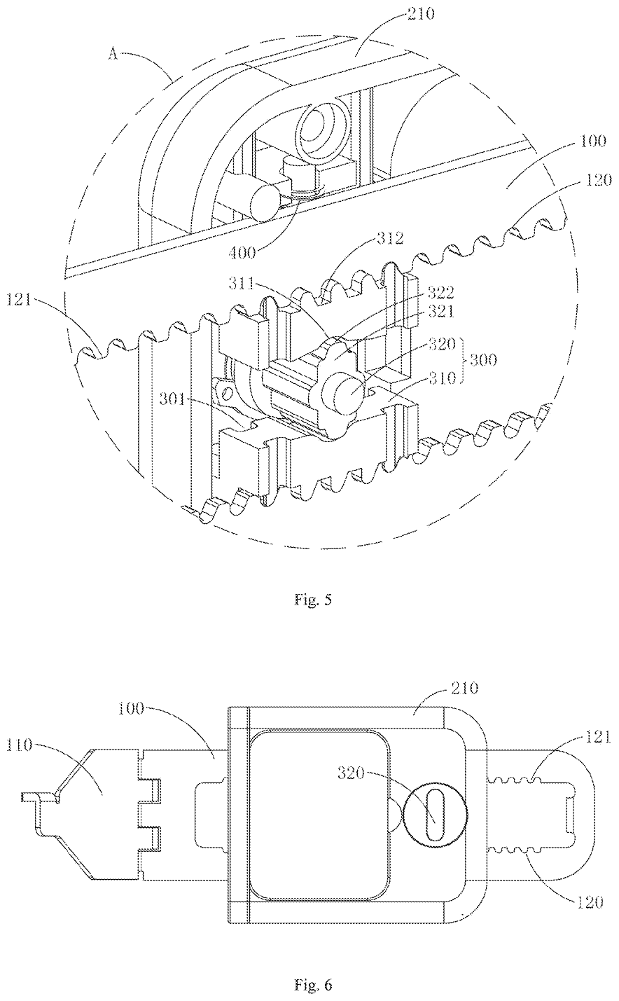

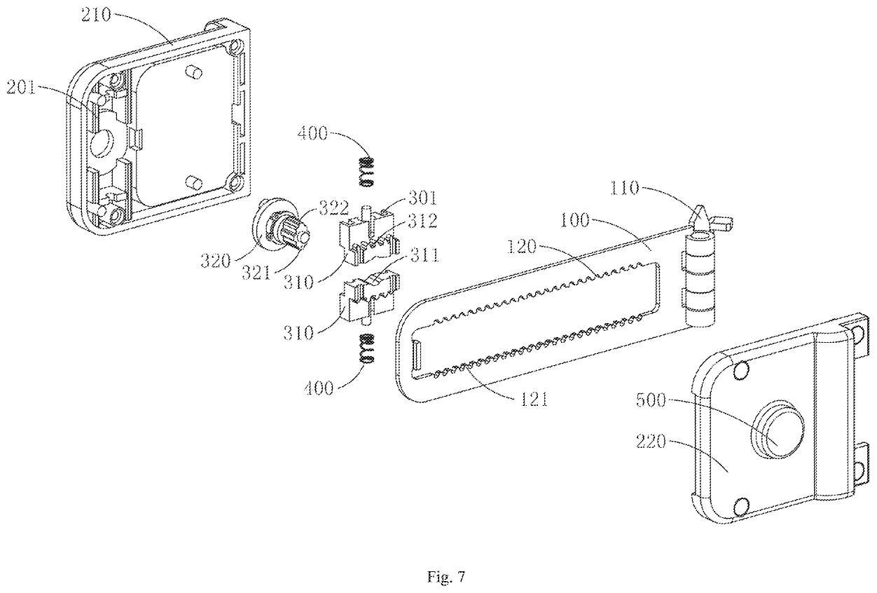

In some embodiments of the disclosure, as shown in FIG. 5 and FIG. 7, the driving piece 320 is provided with a protruding portion 321 arranged on a peripheral wall in a rotating direction of the rotating shaft. The protruding portion 321 is driven to abut against the driven piece 310 by rotating the driving piece 320, and the driven piece 310 is driven to approach to and clamp with the latch structure 120.

Specifically, as shown in FIG. 5 and FIG. 7, the protruding portion 321 will abut against the driven piece 310 when the driving piece 320 rotates, so that the driven piece 310 can be driven to approach to and clamp with the latch structure 120 by the rotating of driving piece 320. The structure is simple, and is easy to implement and convenient for the users to adjust and switch to the locking position.

In some embodiments of the disclosure, as shown in FIG. 5 and FIG. 7, the driving piece 320 is provided with a mating portion 322 on the protruding portion 321, and the driven piece 310 is provided with a groove portion 311 matched with the mating portion 322. When the protruding portion 321 abuts against the driven piece 310, the mating portion 322 can enter and be clamped with the groove portion 311 to lock the locking structure, or separate from the groove portion 311 to unlock the locking structure when the driving piece 320 is applied with a force.

Specifically, as shown in FIG. 5 and FIG. 7, through clamping between the mating portion 322 and the groove portion 311, the locking structure can be locked more firmly and reliably, the clamping stability between the driven piece 310 and the latch structure 120 can be favorably improved, and the door stopping safety of the baffle assembly 200 can be ensured.

In some embodiments of the disclosure, as shown in FIG. 5 and FIG. 7, an outer wall surface of the mating portion 322 and an inner wall surface of the groove portion 311 are arc-shaped. By the rotating the driving piece 320, the mating portion 322 can slide into or out of the groove portion 311 along the inner wall surface of the groove portion 311.

It can be understood that the matching between the arc-shaped wall surfaces of the mating portion 322 and the groove portion 311 can reduce the resistance of the driving piece 320 during rotation and help users to lock or unlock the locking structure more easily.

In some embodiments of the disclosure, as shown in FIG. 5 and FIG. 7, the driven assembly 300 is provided with at least two clamping portions 312 matched with the latches 121, and the at least two clamping portions 312 are configured to be respectively clamped with the latches 121 so as to prevent the baffle assembly 200 from sliding in the length direction of the insertion plate 100.

It should be noted that the at least two clamping portions 312 are arranged and configured to be respectively clamped with the latches 121, so that the clamping force between the driven assembly 300 and the latch structure 120 can be increased, and the driven assembly 300 and the latch structure 120 can be clamped more stably, improving the reliability.

In some embodiments of the disclosure, the driven assembly 300 is connected slidably with the baffle assembly 200. A guiding structure is arranged between the driven assembly 300 and the baffle assembly 200 and configured for limiting a sliding direction of the driven assembly 300. The driven assembly 300 can slide towards and be clamped with or separate from the latch structure 120 via the guiding structure.

It should be noted that the driven assembly 300 can slide towards or away from the latch structure 120 for switching between the locking and unlocking positions via the guiding structure. The structure is simple, and the adjustment of the driven assembly is more accurate.

In some embodiments of the disclosure, as shown in FIG. 4-5 and FIG. 7, the guiding structure includes a sliding block 201 and a sliding groove 301, one of the sliding block 201 and the sliding groove 301 is arranged on the baffle assembly 200, and the other one of the sliding block 201 and the sliding groove 301 is arranged on the driven assembly 300.

Specifically, as shown in FIG. 4-5 and FIG. 7, taking the sliding block 201 arranged on the baffle assembly 200 and the sliding groove 301 arranged on the driven assembly 300 as an example, the sliding block 201 slides along the sliding groove 301 so that the driven assembly 300 can approach to or keep away from the latch structure 120 of the insertion plate 100, and the driven assembly 300 can be clamped with or separated from the latch structure 120. The structure is simple, is convenient to process and assemble and is low in production cost.

In some embodiments of the disclosure, as shown in FIG. 1-4 and FIG. 6-7, the connection portion 110 is rotatably connected with the insertion plate 100, and the insertion plate 100 can flip over relative to the connection portion 110.

It should be noted that during installation and use of the door stopper, the connection portion 110 is needed to be installed in the locking groove of the door pocket first when the door leaf is opened, and then the insertion plate 100 is clamped in the gap between the door leaf and the pocket when door leaf is closed. In the existing door stopper product, the connection portion 110 and the insertion plate 100 are generally integrally formed and the baffle assembly 200 has a certain volume. Therefore, the baffle assembly often collides with the door leaf when being closed, which is inconvenient to use, damages the baffle assembly 200 easily and affects the service life of the door stopper product. If the connection portion 110 is rotatably connected with the insertion plate 100, the connection portion 110 can be fixedly installed in the locking groove of the door pocket, and the insertion plate 100 can flip over relative to the connection portion 110 when the door leaf is closed, so as to keep the baffle assembly 200 at a side of the insertion plate 100 far away from the door leaf and protect it from colliding with the door leaf, which is convenient for the users to close the door, and is also conducive to prolonging the service life of the door stopper. It should be noted that a magnet 500 may be also arranged on the baffle assembly 200 and a magnetic fitting piece may be further arranged on the wall at the side of the door pocket, for example, the magnet 500 may be a magnetic sheet while the magnetic fitting piece may be an iron block. When the insertion plate 100 flips over relative to the connection portion 110, the baffle assembly 200 approaches to the door pocket with the insertion plate 100 and can be fixed on the side of the door pocket due to the attraction between the magnetic sheet and the iron bock, which effectively prevents the baffle assembly from affecting the opening/closing of the door leaf and facilitates the installation/use of the door stopper.

Specifically, to further describe the use of the door stopper, as shown in FIG. 1-7, before installing/using the door stopper, users applies a force to the driving piece 320 first so that the driving piece 320 is rotated and unlocked, and during unlocking, the spring, as the reset structure 400, drives the driven piece 310 to slide by means of the elastic force and separate from the latch structure 120 of the insertion plate 100. At this moment, the baffle assembly 200 can slide in the length direction of the insertion plate 100, so the users can fix the connection portion 110 of the insertion plate on the door leaf when being opened, the insertion plate 100 can be driven to flip over relative to the connection portion, and the baffle assembly 200 can be attracted and fixed on the side of the door pocket away from the door leaf. When the door leaf is closed, the insertion plate 100 is flipped over, the baffle assembly 200 slides towards the connection portion 110 in the length direction of the insertion plate 100 till the movable baffle 210 of the baffle assembly 200 abuts against the door leaf. At this moment, the users can rotate the driving piece 320 to make the driven piece 310 slide toward and clamp with the latch structure 120, so as to prevent the door leaf from being opened from outside and protect the personnel and property safety of the users in the house.

The technical features in the above embodiments can be combined arbitrarily. For brief description, not all possible combinations of the above technical features are described. However, as long as there is no contradiction in the combinations of the technical features, they should be considered as falling within the scope of this specification.

Although the embodiments of the disclosure have been shown and described, a person of ordinary skill in the art can understand that these embodiments can be changed, modified, substituted and transformed without deviating from the principles and purposes of the disclosure, and the scope of the disclosure shall be defined by claims and their equivalents.

1. A door stopper, comprising:
an insertion plate, wherein the insertion plate is provided with a connection portion and a latch structure, the connection portion is configured for connecting with a door leaf or a door pocket, and the latch structure is provided with a plurality of latches arranged in a length direction of the insertion plate;
a baffle assembly, arranged slidably on the insertion plate and configured to slide towards or away from the connection portion in the length direction of the insertion plate;
a driven assembly, movably arranged on the baffle assembly and has unlocking and locking positions on the baffle assembly, wherein at the unlocking position, the driven assembly is separated from the latch structure so as to allow the baffle assembly to slide in the length direction of the insertion plate, and at the locking position, the driven assembly is clamped with the latch structure so as to prevent the baffle assembly from sliding in the length direction of the insertion plate; and the driven assembly is provided with a locking structure which is capable of being locked to keep the driven assembly at the locking position or unlocked when the driven assembly is applied with a force; and
a reset structure, configured for driving the driven assembly to restore to the unlocking position when the locking structure is unlocked.

2. The door stopper according to claim 1, wherein the reset structure comprises an elastic reset piece arranged on the baffle assembly, and the elastic reset piece is connected with the driven assembly so that the driven assembly can restore to the unlocking position by means of an elastic force.

3. The door stopper according to claim 1, wherein the driven assembly comprises a driven piece and a driving piece, the driven piece is movably arranged on the baffle assembly, the driving piece is rotatably connected with the baffle assembly via a rotating shaft, and the driving piece is configured to rotate around the rotating shaft so as to drive the driven piece to clamp with or separate from the latch structure.

4. The door stopper according to claim 3, wherein the driving piece is provided with a protruding portion on a peripheral wall in a rotating direction of the rotating shaft, and by rotating the driving piece, the protruding portion is driven to abut against the driven piece and drive the driven piece to approach to the latch structure so as to be clamped with the latch structure.

5. The door stopper according to claim 4, wherein the driving piece is further provided with a mating portion on the protruding portion, the driven piece is provided with a groove portion matched with the mating portion; when the protruding portion abuts against the driven piece, the mating portion is capable of entering the groove portion and clamping with the groove portion to lock the locking structure, and when the driving piece is applied with a force, the mating portion is capable of being separated from the groove portion so as to unlock the locking structure.

6. The door stopper according to claim 5, wherein an outer wall surface of the mating portion and an inner wall surface of the groove portion are arc-shaped, and by rotating the driving piece, the mating portion is capable of sliding into or out of the groove portion along the inner wall surface of the groove portion.

7. The door stopper according to claim 1, wherein the driven assembly is provided with at least two clamping portions matched with the latches, and the at least two clamping portions are configured to be respectively clamped with the latches so as to prevent the baffle assembly from sliding in the length direction of the insertion plate.

8. The door stopper according to claim 1, wherein the driven assembly is connected slidably with the baffle assembly, a guiding structure is arranged between the driven assembly and the baffle assembly and configured for limiting a sliding direction of the driven assembly, the driven assembly is configured to slide towards and be clamped with the latch structure or slide away and separated from the latch structure via the guiding structure.

9. The door stopper according to claim 8, wherein the guiding structure comprises a sliding block and a sliding groove, one of the sliding block and the sliding groove is arranged on the baffle assembly, and the other one of the sliding block and the sliding groove is arranged on the driven assembly.

10. The door stopper according to claim 1, wherein the connection portion is rotatably connected with the insertion plate, and the insertion plate is capable of flipping over relative to the connection portion.
